(19) United States
(12) Patent Application Publication
(10) Pub. No.: US 2018/0090238 A1
(43) Pub. Date: Mar. 29, 2018

(54) MUON-CATALYZED CONTROLLED FUSION ELECTRICITY-GENERATING APPARATUS AND METHOD

(71) Applicant: Jerome Drexler, Los Altos Hills, CA (US)

(72) Inventor: Jerome Drexler, Los Altos Hills, CA (US)

(21) Appl. No.: 15/631,225

(22) Filed: Jun. 23, 2017

Related U.S. Application Data
(60) Provisional application No. 62/398,710, filed on Sep. 23, 2016.

(51) Int. Cl. G21D 7/00; H02K 7/18; G21B 1/19; G21D 1/02

(52) U.S. Cl. CPC G21D 7/00; G21D 1/02; G21B 1/19; H02K 7/1823

(57) ABSTRACT

A turbine generator for producing electricity is described for use on planets and moons, or corresponding planetary or lunar orbits, where magnetic fields and atmospheres are sufficient low to obtain an adequate ambient flux of cosmic rays and muons for useful micro-fusion. A source of deuterium-containing micro-fusion particle fuel material is supplied via a flue to a columnar reaction volume, where it is dispersed and interacts with incoming cosmic rays and muons. Nuclear micro-fusion products (energetic alpha particles) drive a set of helium-wind turbines arranged around the reaction volume. Electrical generators coupled to the turbines generate electricity to supply nearby habitats and equipment.

### CROSS-REFERENCE TO RELATED APPLICATION

This application claims priority under 35 U.S.C. 119(e) from prior U.S. provisional application 62/398,710 filed Sep. 23, 2016.

### TECHNICAL FIELD

The present invention relates to generation of electric power, and in particular to methods and apparatus employing muon-catalyzed nuclear fusion for use in interplanetary space and on surfaces of the Moon, Mars and other planets or moons with little or no magnetic field and/or atmosphere.

### BACKGROUND ART

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an earth-based fusion source, since it falls short of break-even potential.

Another controlled fusion technique is particle-target fusion which comes from accelerating a particle to sufficient energy so as to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that cosmic rays are abundant in interplanetary space. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 5 shows cosmic ray flux distribution at the Earth's surface after significant absorption by Earth' atmosphere has occurred. In near-Earth space, the alpha magnetic spectrometer (AMS-02) instrument aboard the International Space Station since 2011 has recorded an average of 45 million fast cosmic ray particles daily (approx. 500 per second). The overall flux of galactic cosmic ray protons (above earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space), the cosmic ray flux is expected to be several orders of magnitude greater. As measured by the Martian Radiation Experiment (MARIE) aboard the Mars Odyssey spacecraft, average in-orbit cosmic ray doses were about 400-500 mSv per year, which is an order of magnitude higher than on Earth.

Cosmic rays are known to generate abundant muons from the decay of cosmic rays passing through Earth's atmosphere. Cosmic rays lose energy upon collisions with atmospheric dust, and to a lesser extent atoms or molecules, generating elementary particles, including pions and then muons, usually within a penetration distance of a few cm. Typically, hundreds of muons are generated per cosmic ray particle from successive collisions. Near sea level on Earth, the flux of muons generated by the cosmic rays' interaction by the atmosphere averages about 70 m⁻²s⁻¹sr⁻¹. The muon flux is even higher in the upper atmosphere. These relatively low flux levels on Earth reflect the fact that both Earth's atmosphere and geomagnetic field substantially shields our planet from cosmic ray radiation. Mars is a different story, having very little atmosphere (only 0.6% of Earth's pressure) and no magnetic field, so that muon generation at Mars' surface is expected to be very much higher than on Earth's surface. Planetary moons, such as Phobos and Deimos around Mars, would experience similar high levels of cosmic ray flux and consequent muon generation.

In recent years, there have been proposals to send further spacecraft to Mars in 2018 and then manned space vehicles to Mars by 2025. One such development project is the Mars Colonial Transporter by the private U.S. company SpaceX with plans for a first launch in 2022 followed by flights with passengers in 2024. The United States has committed NASA to a long-term goal of human spaceflight and exploration beyond low-earth orbit, including crewed missions toward eventually achieving the extension of human presence throughout the solar system and potential human habitation on another celestial body (e.g., the Moon, Mars). As part of any manned exploration and human habitation of Mars, some form of electricity generation will be needed beyond that available from solar cells in order to power the habitats, life support, and scientific equipment.

### SUMMARY DISCLOSURE

An electrical generation apparatus is provided that employs a muon-catalyzed controlled nuclear micro-fusion method to create a “wind” of large numbers of high-energy helium nuclei to drive a set of turbines. These “helium-wind” turbines are mechanically connected to a corresponding number of induction generators to produce electricity.

A cloud of fusion material is suspended within a reaction chamber and is bombarded with incoming cosmic rays and muons arriving through the top of the chamber. Turbines arranged around the reaction chamber can be driven by energetic products, such as alpha particles, in order to create electricity.

The present invention takes advantage of the abundance of cosmic rays and generated muons on any planet or moon with a weak (or no) magnetic field and a thin atmosphere, as well as in planetary or lunar orbit or interplanetary space, to catalyze fusion events. The cosmic rays and muons are available here for free and do not need to be generated artificially in an accelerator. Fusion material will interact with the flux of cosmic rays and muons such that some combination of particle-target fusion and/or muon-catalyzed fusion will take place. One cosmic ray particle can generate hundreds of muons, and each muon can typically catalyze about 100 fusion reactions before it decays (the exact number depending on the muon “sticking” cross-section to any helium fusion products). Additionally, any remaining cosmic rays can themselves directly stimulate a fusion event by particle-target fusion, wherein the high energy cosmic ray particles (mostly protons, but also helium nuclei) bombard relatively stationary target material.

For example, the thin atmosphere on Mars (0.6% of Earth's pressure) allows a substantial flux of cosmic rays to reach the planetary surface and its high mountains. Therefore, presenting fusion target material (lithium-6 deuteride, heavy water, liquid deuterium, etc.) on the surface of Mars can make use of the muon generation from such cosmic rays to catalyze fusion. Likewise, there are an abundance of cosmic rays in space such that fusion products can be created to generate electricity on orbital platforms, such as a space station. Since the amount of generated energy is on the order of kilowatts, which is very much less than the fusion energy outputs or yields typical of atomic weapons, “micro-fusion” is the term used here to refer to fusion energy outputs of not more than 10 gigajoules per second (2.5 tons of TNT equivalent per second), to thereby exclude runaway macro-fusion-type explosions.

### BRIEF DESCRIPTION OF THE DRAWINGS

FIG. 1 is a schematic side view of a micro-fusion-driven turbine generator apparatus supplying electricity to planetary or lunar habitats.

FIG. 2 is a schematic plan view of a micro-fusion-driven turbine generator apparatus in accord with the present invention, shown operating on the surface of a moon or planet other than Earth.

FIG. 3 is a top plan view of the reaction volume of the turbine generator apparatus of FIG. 2 showing an arrangement of turbines and generators circumferentially around a reaction volume.

FIG. 4 is a side plan view of the reaction volume of a turbine generator apparatus as in FIG. 2, but with turbines and generators in a vertically stacked arrangement along a length of the reaction volume.

FIG. 5 is a graph of cosmic ray flux at the Earth surface versus cosmic ray energy, after very significant cosmic ray absorption by Earth's atmosphere has occurred.

### DETAILED DESCRIPTION

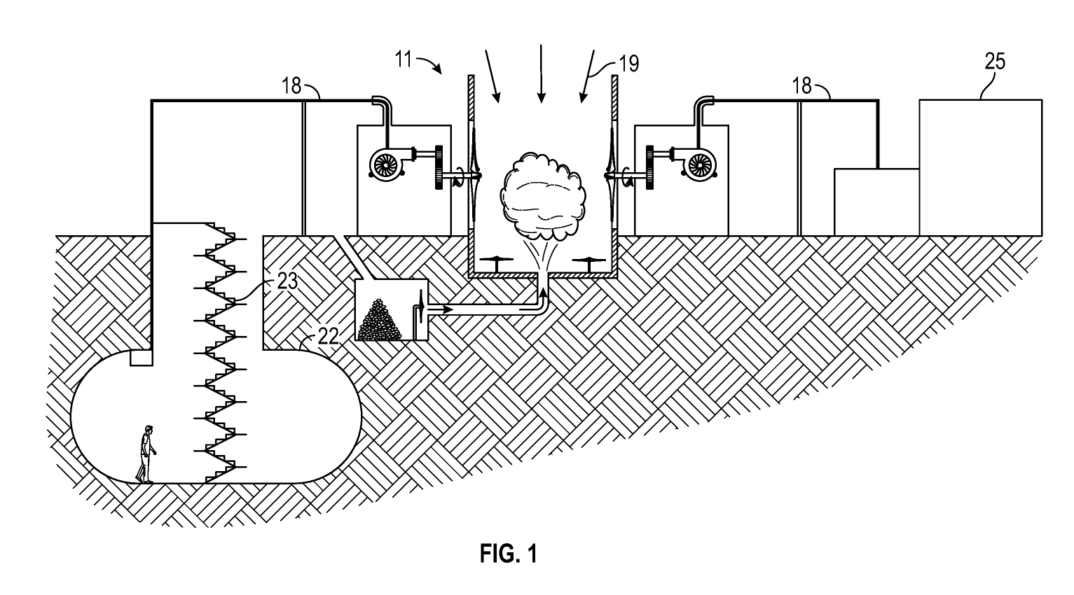

FIG. 1 shows a turbine electric generator apparatus 11 located outside of an arrangement of habitats 22 and 25 on a planetary or lunar surface, where generators are powered by reaction of ambient cosmic rays and muons with a dispersed cloud of micro-fusion fuel within a reaction volume of the apparatus 11. Electrical power lines 18 lead from the generator apparatus 11 to the various habitats. Some habitats might be underground, as in habitat 22, which might be accessible via a stairwell 23. Electrical power lines 18 could feed electricity to the habitat 22 via conduits along the same access column that supports the stairwell. Other habitats might be above ground, as in habitat 25, powered by electricity supplied via external power lines 18. In accord with the invention, the generator apparatus 11 has turbines driven by fast helium nuclei micro-fusion products generated from dispersed lithium-6 deuteride or other deuterium-containing micro-fusion target material exposed to the cosmic rays and muons.

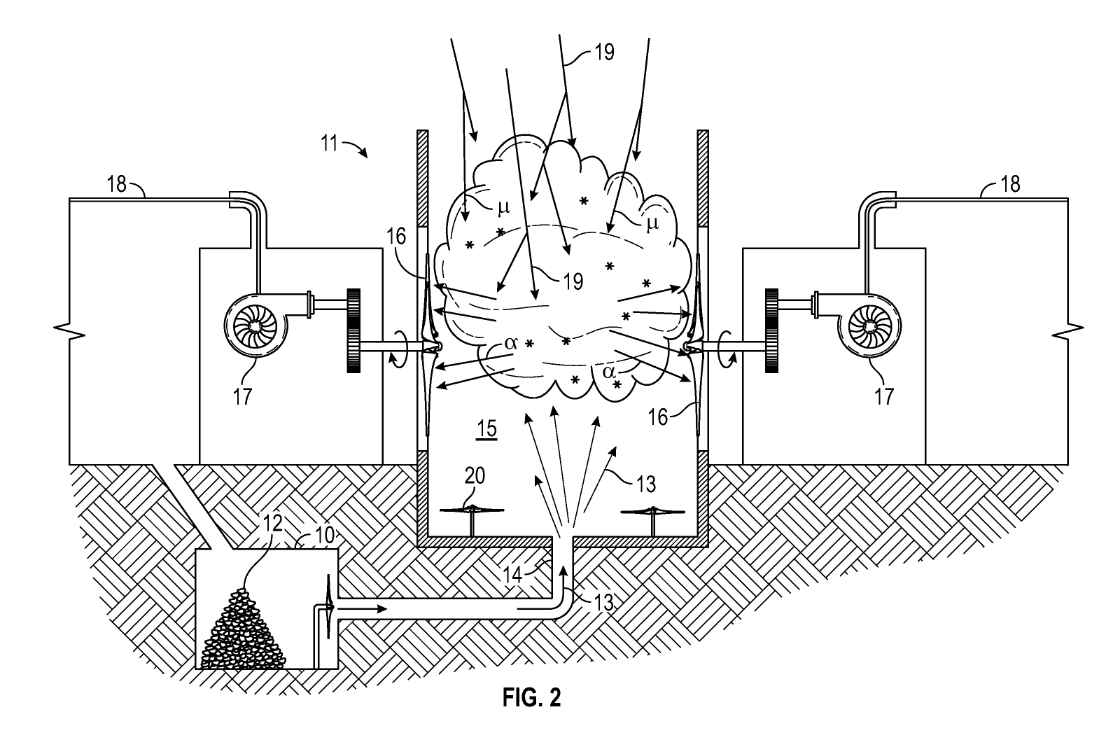

With reference to FIG. 2, micro-fusion-driven turbine generators, when in the presence of sufficient ambient flux of cosmic rays and muons, provides electricity to one or more planetary, lunar, or orbital habitats. Specifically, in a generator assembly 11 includes a source 10 of deuterium-containing micro-fusion particle fuel material 12. This material could be blown 13 through a flue 14, e.g. by means of a fan at the source 10 or by other means, depending on the form that the fuel material takes, and dispersed from the flue 14 into a reaction volume 15. The micro-fusion target fuel material 13 is dispersed in proximity to turbines 16 arranged around the reaction volume 15, and then exposed to ambient cosmic rays 19 and muons μ that enters the volume 15 and interacts with the dispersed fuel material 13 to cause nuclear micro-fusion events. A “wind” of micro-fusion products made up of energetic helium (alpha products) impinge upon and direct kinetic energy to the turbine blades 16 to turn the turbines and drive the associated generators 17 to produce electricity which can then be supplied via electric cables 18 to the habitats and other equipment. A set of one or more fans 20 in the reaction volume 15 may help keep the fuel material in suspension near the turbines 16.

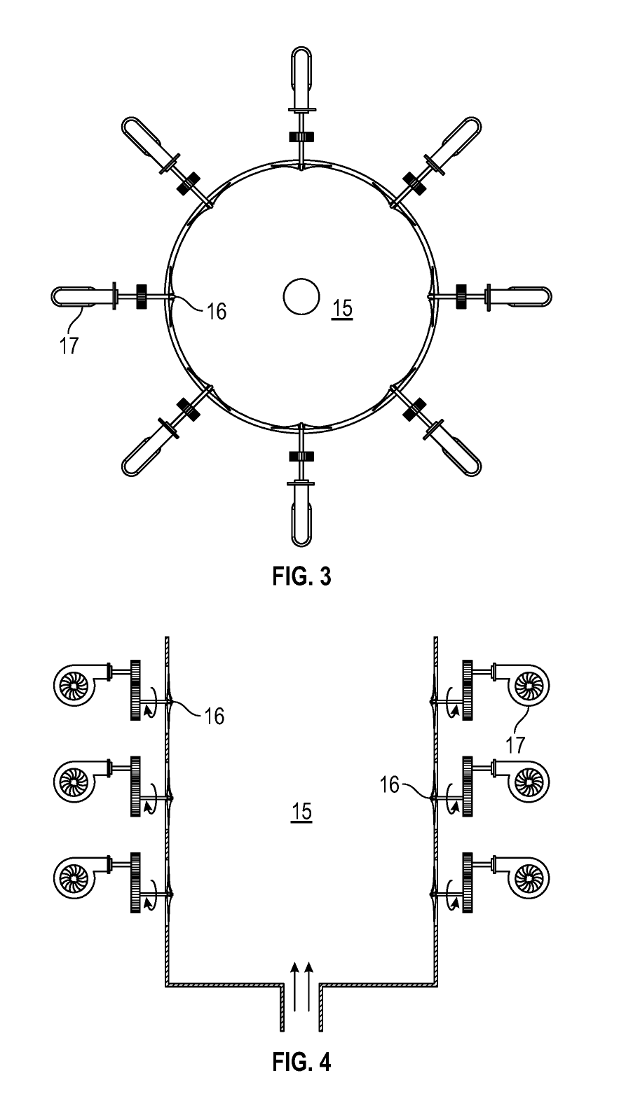

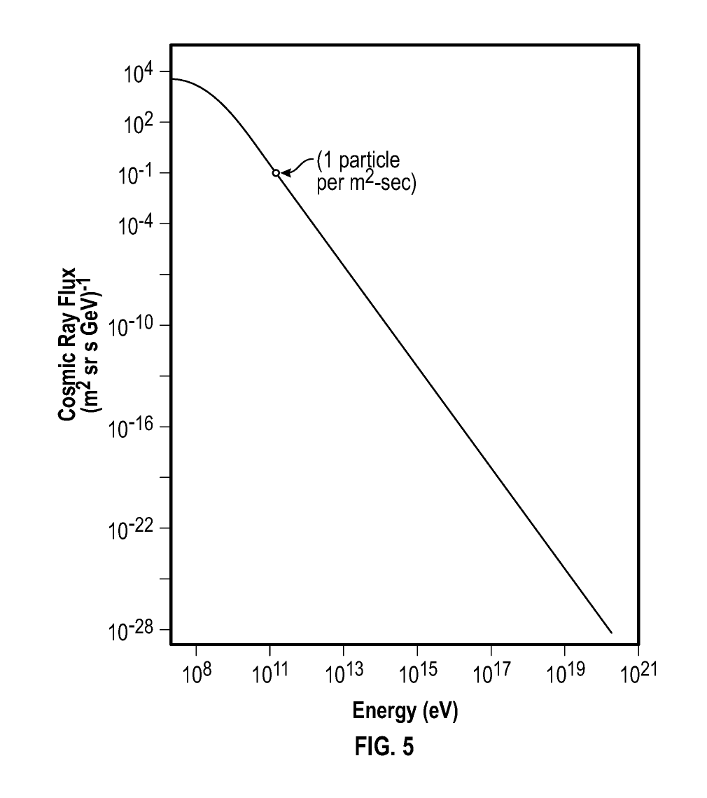

As seen in FIG. 3, the turbines 16 may be arranged around the circumference of the reaction volume 15, which can be cylindrical or any other equivalent columnar shape. While typically four in number, there can anywhere from as few as two up to 20 or more such turbines 16 (eight are seen here), depending on the space available, the size of the fusion reaction cloud, and the size and arrangement of the turbines themselves about the chamber 15. Alternatively, or in addition, as seen in FIG. 4, the turbines 16 may be arranged in multiple stacks along the length of the cylindrical reaction volume 15. Turbines are connected, e.g. through gearboxes, to corresponding induction generators 17. The generators 17 may be equal in number to the corresponding turbines 16 (1:1 correspondence), or multiple turbines may drive any given generator (n:1 correspondence).

On planetary or lunar surfaces, the chamber may be arranged with its cylindrical or columnar axis pointing in a vertical direction, since cosmic rays and generated muons will be arriving from above. Likewise, in an orbit the planet or moon below will shield in-coming cosmic rays and there may be some shielding from the orbiting platform itself, such that the chamber will should be located and pointed in a direction that will maximize receipt of cosmic rays onto the cloud of fusion target material within the chamber.

The deuterium “fuel” may be supplied in the form of clouds of solid lithium-6 deuteride powder, pellets or chips, or even frozen heavy water (D₂O) or liquid droplets of. D₂, to a reaction chamber 15, where it is exposed to incoming cosmic rays 19 and muons μ. One technique for creating the cloud of fusion target material is to shoot “fuel” packages as a series of projectiles into the reaction chamber, which can then disperse the fusion material as a localized cloud, much like fireworks or artillery. For this purpose, one or more gun tubes may be located below the chamber and loaded with the packages for introduction into the chamber. Alternatively, packages may be dropped into the chamber from near the top via a slide dispenser. The fuel within the projectile packages can be solid Li⁶D in powder form, D-D or D-T inertial-confinement-fusion-type pellets, or D₂O ice crystals. Packages will be shielded, at least within the casing of the projectiles themselves, to reduce or eliminate premature fusion events until delivered and dispersed as a cloud in the reaction chamber. Soon after the projectile has reached the desired dispersal location within the chamber, the package releases its target material. For example, a chemical explosion can be used to locally disperse the fusion material. For a typical cloud of Li⁶D in powder form it may be desired to disperse the material near the top of the chamber to allow maximum usage of the material while it settles toward the bottom of the chamber. It might be advantageous to provide one or more fans 20 at the bottom of the chamber 15 to keep the cloud of target material suspended in the chamber as long as possible.

The present invention achieves nuclear micro-fusion using deuterium-containing target material, and the ambient flux of cosmic rays and generated muons that are already naturally present. The dispersed cloud of target material will be exposed to both cosmic rays and to their generated muons. As cosmic rays collide with fusion targets and dust, they form muons that are captured by the deuterium and that catalyze fusion. Likewise, the cosmic ray collisions themselves can directly trigger particle-target fusion.

Besides D-D fusion reactions, other types of fusion reactions may also occur (e.g. D-T, using tritium generated by cosmic rays impacting the lithium; as well as Li⁶-D reactions from direct cosmic ray collisions). In order to assist muon formation, especially when D₂O is used, the target package may contain up to 20% by weight of added particles of fine sand or dust. (This is particularly important if one desires to create a similar fusion reaction on the Moon, which has no atmosphere.) Muonic deuterium, tritium or lithium-6 can come much closer to the nucleus of a similar neighboring atom with a probability of fusing deuterium nuclei, releasing energy. Once a muonic molecule is formed, fusion proceeds extremely rapidly (on the order of 10⁻¹⁰ sec). One cosmic ray particle can generate hundreds of muons, and each muon can typically catalyze about 100 fusion reactions before it decays (the exact number depending on the muon “sticking” cross-section to any helium fusion products). For example, a particularly desired reaction is Li⁶+D→2He⁴+22.4 MeV, where much of the useful excess energy is carried as kinetic energy of the two helium nuclei (alpha particles). The alpha particles then provide a motive force to turbine blades for the generation of electricity. Other fusion reactions also create energetic fusion products that can drive the turbines.

Additionally, any remaining cosmic rays can themselves directly stimulate a fusion event by particle-target fusion, wherein the high energy cosmic ray particles (mostly protons, but also helium nuclei) bombard the cloud of target material. When bombarded directly with cosmic rays, the lithium may be transmuted into tritium which could form the basis for some D-T fusion reactions. Although D-D fusion reactions occur at a rate only 1% of D-T fusion, and produce only 20% of the energy by comparison, the freely available flux of cosmic rays and their generated muons should be sufficient to yield sufficient fusion energy output for practical use.

The optimum concentration of the cloud of target material for the particle-target and muon-catalyzed fusion may be determined experimentally based on the particular abundance of cosmic rays with a view to maintaining a chain reaction of fusion events for producing adequate thrust against the turbine blades, while avoiding any possibility of runaway fusion.

The present invention achieves muon-catalyzed nuclear fusion using deuterium-containing target material, and muons that are naturally created from ambient cosmic rays. Most cosmic rays are energetic enough to create multiple muons (often several hundred) by successive collisions with atmospheric dust or with the atoms in a target. In fact, most cosmic rays have GeV energies, although some extremely energetic ones can exceed 10¹⁸ eV and therefore potentially generate millions of muons. The optimum concentration of the target material for the muon-catalyzed fusion may be determined experimentally based on the particular abundance of cosmic rays with a view to maintaining a chain reaction of fusion events for driving the electrical generating turbines.

Because both particle-target fusion and muon-catalyzed fusion, while recognized scientifically, are still experimentally immature technologies (since measurements have only been conducted to date on Earth using artificially accelerated particles and generated muons from particle accelerators), various embodiments of the present invention can have research utility to demonstrate feasibility in environments beyond Earth's protective atmosphere and/or geomagnetic field. First, a satellite platform in Earth orbit (for example, on the International Space Station) and then later a lander on the surface of the Moon are both conveniently close to Earth to place experimental modules in order to determine optimum parameters (e.g. dimensions of the chamber, and cloud density for different fuel types) in order to adequately drive the turbines.

What is claimed is:

1. A micro-fusion-driven turbine generator for producing electricity in the presence of ambient flux of cosmic rays and muons, comprising:
a source of deuterium-containing micro-fusion particle fuel material;
a reaction volume;
a flue coupled to the source and reaction volume for dispersing fuel material into the reaction volume;
a set of helium-wind turbines arranged around the reaction volume, wherein cosmic rays and muons entering the volume interact with the dispersed fuel material to cause nuclear micro-fusion events, kinetic-energy containing micro-fusion products driving the helium-wind turbines; and
a set of electrical generators coupled to the respective helium-wind turbines to convert mechanical motion of the driven turbines into electricity.

2. The generator as in claim 1, wherein the deuterium-containing fuel material comprises Li⁶D.

3. The generator as in claim 1, wherein the deuterium-containing fuel material comprises D₂O.

4. The generator as in claim 1, wherein the deuterium-containing fuel material comprises D₂.

5. The generator as in claim 1, wherein the deuterium-containing fuel material is in solid powder form.

6. The generator as in claim 1, wherein the deuterium-containing fuel material is in pellet or chip form.

7. The generator as in claim 1, wherein the deuterium-containing fuel material is in frozen form.

8. The generator as in claim 1, wherein the deuterium-containing fuel material is in liquid droplet form.

9. The generator as in claim 1, wherein the deuterium-containing fuel material also contains up to 20% by weight of added particles of fine sand or dust.

10. The generator as in claim 1, wherein the reaction volume is a cylinder with an opening at one end to receive the cosmic rays and muons.

11. The generator as in claim 10, wherein the turbines are arranged radially around the circumference of the cylinder reaction volume.

12. The generator as in claim 10, wherein turbines are stacked vertically in multiple layers along a length of the cylinder reaction volume.

13. The generator as in claim 1, wherein one or more fans are provided in the reaction volume to maintain the dispersed fuel material in suspension within the reaction volume.
